(19) United States
(12) Patent Application Publication
(10) Pub. No.: US 2026/0215393 A1
(43) Pub. Date: Jul. 30, 2026

(54) ADJUSTABLE PET RAMPS

(71) Applicant: Oscar Brown LLC, Austin, TX (US)

(72) Inventor: David Segall, Austin, TX (US)

(73) Assignee: Oscar Brown LLC, Austin, TX (US)

(21) Appl. No.: 19/461,377

(22) Filed: Jan. 27, 2026

Related U.S. Application Data
(60) Provisional application No. 63/751,200, filed on Jan. 29, 2025.

(51) Int. Cl. A01K 1/035

(52) U.S. Cl. CPC A01K 1/035

(57) ABSTRACT

Described herein is an adjustable ramp that includes a telescopic column comprising an outer column and a vertically adjustable inner column, actuated via a height-adjustment mechanism. A stable, anti-slip base supports the telescopic column. An extendable ramp is pivotally connected to the column via a hinge mechanism and includes an outer ramp and a slidable inner ramp for adjustable length. A lip at the ramp’s end is configured to securely engage elevated surfaces. A replaceable upholstery cover is attachable along the ramp surface to provide a textured, non-slip area for pet traction and to conceal excess material during extension. The ramp may further include modular elements for example interlocking tiles, snap-fit brackets, and interchangeable feet for compatibility with various floor surfaces. The structure is designed to offer ergonomic access for pets to elevated areas, improved adjustability, compact storage, and user-friendly maintenance, while maintaining aesthetic integration for indoor environments.

### CROSS-REFERENCE TO RELATED APPLICATIONS

The present application claims the benefit of U.S. Provisional Patent Application No. 63/751,200 entitled “ADJUSTABLE PET RAMPS”, filed on January 29, 2025. The entire contents of the above-listed application are hereby incorporated by reference for all purposes.

### BACKGROUND

Pet mobility aids are designed to assist animals in navigating environments with varying elevations, for example furniture, steps, or vehicles, by providing safe and accessible pathways for movement. These aids help reduce physical strain on pet owners while promoting the independence and mobility of pets in a variety of settings. Within this general field, there is a growing focus on ramps for indoor and household use to enable pets to safely and comfortably access elevated surfaces.

### BRIEF DESCRIPTION OF THE DRAWINGS

The present description will be understood more fully when viewed with the accompanying drawings of examples of adjustable pet ramps. The description is not meant to limit the adjustable pet ramps to the specific examples. Rather, the specific examples depicted and described are provided for explanation and understanding of adjustable pet ramps. Throughout the description, the drawings may be referred to as drawings, figures, and/or FIGs.

FIG. 1 illustrates an exploded perspective view of a pet ramp with a telescopic column, according to an embodiment.

FIG. 2 illustrates a top-down view of the pet ramp, according to an embodiment.

FIG. 3 illustrates a perspective view of the pet ramp in its assembled and operational configuration, according to an embodiment.

FIG. 4 illustrates a cross-sectional view of a telescopic column assembly of a pet ramp, according to an embodiment.

FIG. 5 illustrates a perspective view of a replaceable upholstery cover of a pet ramp, according to an embodiment.

FIG. 6 illustrates a perspective view of a ramp in a fully deployed state, according to an embodiment.

FIG. 7 illustrates a perspective underside view of a ramp in a fully deployed state, according to an embodiment.

FIG. 8 illustrates a perspective view of a folding mechanism, according to an embodiment.

FIG. 9 illustrates a cross-sectional view of a folding mechanism, according to an embodiment.

### DETAILED DESCRIPTION

An adjustable pet ramp as disclosed herein will become better understood by reviewing the following detailed description in conjunction with the figures. The detailed description and figures provide merely examples of the various embodiments of adjustable pet ramps. Many variations are contemplated for different applications and design considerations; however, for brevity and clarity, all the contemplated variations may not be individually described in the following detailed description. Those skilled in the art will understand how the disclosed examples may be varied, modified, and altered and not depart in substance from the scope of the examples described herein.]

A conventional pet ramp may include a fixed-length inclined surface supported by a frame or a base, allowing pets to access elevated surfaces for example beds, couches, or vehicles. These ramps are typically constructed using materials like wood, plastic, or aluminum and may feature non-slip surfaces to improve traction for pets. These ramps, however, often prioritize functionality over aesthetic integration with household environments and may lack the structural durability desired for consistent use by larger or more active pets.

Despite their use, current pet ramps exhibit several limitations and areas for improvement. Fixed-length ramps can be bulky, difficult to store, and unsuitable for households with limited space. Conventional models are often not adjustable and lack precision in height settings and may compromise stability, leading to potential safety risks for pets. Furthermore, conventional ramps typically neglect user convenience and aesthetic considerations, resulting in products that are difficult to clean, replace, or blend into household settings. These challenges present opportunities for innovation in developing pet ramps that are adjustable, more stable, customizable, and user-friendly while maintaining a visually appealing design.

Implementations of an adjustable pet ramp may address some or all of the problems described above. An adjustable pet ramp may include a telescoping configuration with an outer and inner ramp that allows for various length adjustments and is supported by a central telescopic column with a height-adjustment mechanism. The ramp may include a replaceable upholstery cover and provide a safe, grippy surface for pets. Additional features could include a stable, anti-slip base, attachment mechanisms for securing a part of the ramp to elevated surfaces, and modular components.

The disclosed embodiments address these problems and opportunities by combining components that improve safety, functionality, and aesthetic appeal. The telescoping column and adjustable ramp sections allow the ramp to be adjusted to various heights and spaces, which eliminates the bulkiness and instability of fixed or poorly adjustable models. The replaceable upholstery cover, stable base and various attachment mechanisms make the ramp safe for pets of varying sizes. These improvements create a pet ramp that meets practical needs and is also aesthetically appealing.

In an embodiment of the disclosure relates to an adjustable pet ramp that enables safe and ergonomic access for pets to elevated surfaces. This ramp comprises a foldable base, telescoping supports, and replaceable step and ramp surfaces. Components can be modularly assembled or adjusted to accommodate different use scenarios. Materials are selected to enhance grip, safety, and ease of storage.

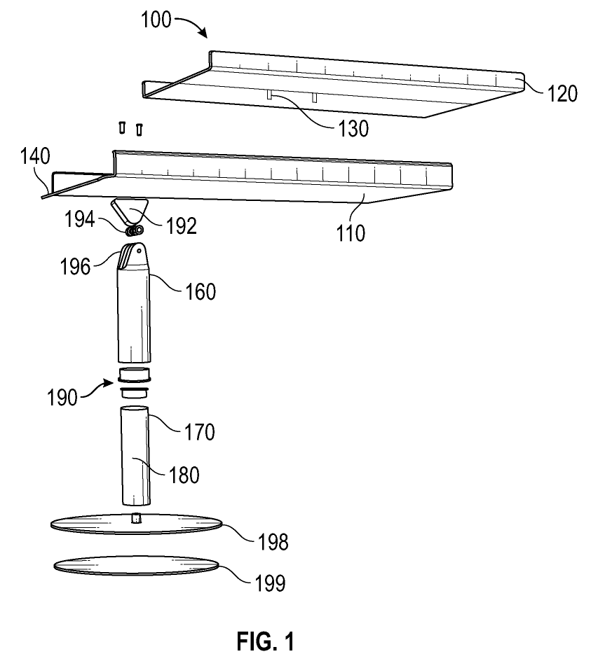

FIG. 1 illustrates an exploded perspective view of a ramp 100 with a telescopic column, according to an embodiment. The ramp 100 is designed to help pets safely access elevated surfaces, for example furniture, while providing a stable, adjustable, and aesthetically pleasing structure suitable for household use. The ramp 100 may be extendable or adjustable in length or width. The ramp 100 includes an outer ramp 110 and an inner ramp 120, both of which are adjustable in length. The inner ramp 120 slides outward relative to the outer ramp 110 and is secured in position using fasteners, for example wing nuts 130, locking pins, or other suitable connectors that allow for smooth extension and retraction of the inner ramp 120 relative to the outer ramp 110. This configuration enables the ramp 100 to be adjusted both in length and angle, allowing it to accommodate a wide range of applications, for example providing access to furniture of varying heights or creating a more gradual incline for pets with limited mobility. The top of the ramp 100 includes a lip 140 configured to engage elevated surfaces, for example the edge of furniture or similar structures. The lip 140 is constructed with a raised edge and a flat underside that conforms to the surface it engages. This configuration provides a tight, gap-free connection that may prevent slipping, shifting, or instability when the ramp 100 is in use. The raised edge of the lip 140 also acts as a barrier to prevent the ramp from sliding off or disengaging from the elevated surface during use.

The ramp 100 is supported by a telescopic column 150, which serves as the support mechanism for the ramp 100. The telescopic column 150 is configured to provide stability and controlled height adjustability for the ramp 100. In an embodiment, the telescopic column 150 includes an outer column 160 and an inner column 170. The outer column 160 houses a height-adjustment mechanism, for example a threaded rod 180, which extends longitudinally and interacts with a securing mechanism, for example a nut 190, attached to an end cap of the inner column 170. The threaded rod 180 and nut 190 mechanism allow the inner column 170 to be adjusted vertically with precision, enabling the ramp 100 to accommodate various heights. Alternatively, other adjustment mechanisms, for example a screw-drive system, a rack and pinion assembly, or a hydraulic lift system, may be employed to achieve similar functionality. The telescopic column 150 is further stabilized by a round, anti-slip, and anti-scratch base 198, which rests securely on the floor. The base 198 may include a textured, non-slip surface to prevent lateral movement and to protect delicate floor surfaces, for example hardwood or tile, from scratches or damage. In an embodiment, the base 198 may include an attachable anti-slip layer or material 199.

To provide smooth operation and prevent wear, a glider or glider assembly including the nut 190, is positioned between the inner column 170 and the outer column 160. The glider assembly may include the nut 190, the inner column 170, and the outer column 160. The glider assembly is made of a low-friction material, for example nylon or PTFE (polytetrafluoroethylene), and is dimensioned to match the inner column 170 diameter with precise tolerances. This glide assembly minimizes friction during height adjustment, prevents metal-to-metal contact between the columns, and reduces wear of the telescopic column 150. The term “telescopic column” may mean an adjustable height column that is configured to allow the inner column 170 to move smoothly within the outer column 160 to achieve precise height adjustments.

A portion of the telescoping column 150 includes a connection mechanism 196 that is configured to attach to the surface of the outer ramp 110. In an embodiment, this connection mechanism incorporates a pivotable joint that allows for angular adjustments between the telescoping column 150 and the outer ramp 110. The pivot mechanism may include a pin 194, which extends transversely through aligned apertures in both the connection mechanism and a corresponding bracket 192 affixed to the surface of the outer ramp 110.

The pin 194 allows the connection mechanism 196 to rotate about its axis, thereby enabling the ramp 100 to pivot relative to the telescoping column 150. The pin 194 may secured in place by a retaining clip or a threaded fastener. In another embodiment, the pivot mechanism may include a ball joint.

The ramp 100 further includes a detachable and replaceable upholstery cover. The upholstery cover is configured to provide a textured surface for pets to maintain a secure grip when using the ramp. The cover is configured to adjust in length to match the extended or retracted position of the ramp 100. The upholstery cover conceals any excess material beneath or above the ramp structure. The cover may be made from materials for example fabric, rubberized textile, or other non-slip materials and can be easily replaced or cleaned.

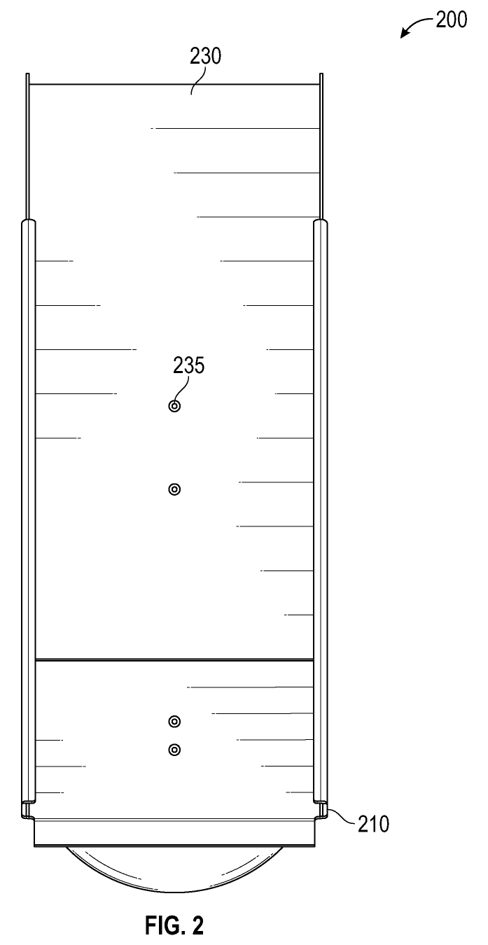

FIG. 2 illustrates a top-down view of the ramp 200, according to an embodiment. The figure shows the structural alignment and relationship between the outer ramp 210 and the inner ramp 220. The outer ramp 210 is depicted as a rectangular frame with parallel side edges and provides the primary structure for the ramp. Within the outer ramp 210, the inner ramp 220 is positioned centrally and is aligned to slide longitudinally relative to the outer ramp 210. This configuration allows for precise extension and retraction of the inner ramp 220

Fasteners 235 are shown symmetrically positioned along the central axis of the ramps. These fasteners are configured to secure the inner ramp 220 in place relative to the outer ramp 210 during adjustments to provide stability and prevent unwanted movement when the ramp is in use. In this embodiment, the fasteners 235 are evenly spaced to uniformly distribute the load across the ramp structure. This may reduce stress on any one point. In other embodiments, the fasteners could be positioned asymmetrically, grouped closer to specific sections of the ramps for specialized applications, or even replaced by other securing mechanisms, for example locking pins, clamps, sliding brackets, or tension bolts.

The bottom edge of the ramp assembly may be the termination point for the ramp structure. This bottom edge functions as the foundational reference plane for the entire ramp assembly. The straight, parallel edges of the outer ramp 210 and inner ramp 220 are configured to maintain consistent spacing and dimensional accuracy. This embodiment reduces the potential for lateral displacement or torsional forces during use.

The symmetrical configuration of the ramp components allows the inner ramp 220 to move along a controlled linear trajectory within the outer ramp 210. This movement is facilitated by the precisely maintained tolerances between the two ramps, which minimize lateral play and reduce wear on the sliding surfaces over time. The ramp's continuous and unobstructed surface is configured to provide a uniform load-bearing pathway. This configuration ensures that pets can safely ascend and descend elevated surfaces without instability or the risk of structural failure, even under dynamic load conditions, for example when pets jump onto or off the ramp.

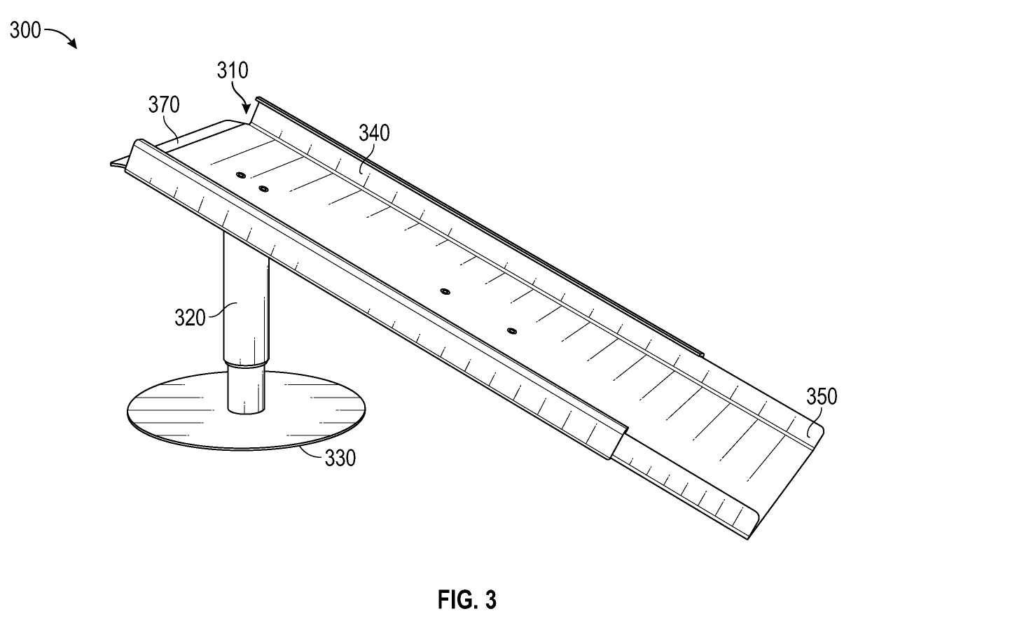

FIG. 3 illustrates a perspective view of the ramp 300 in its assembled and operational configuration, according to an embodiment. The ramp 300 includes an adjustable ramp assembly 310 supported by a central telescopic column 320, which is mounted on a round, anti-slip base 330. This configuration provides a stable and adjustable structure configured to accommodate various elevated surfaces, for example furniture or beds, for pets to safely ascend or descend.

The ramp assembly 310 includes an outer ramp 340 and an inner ramp 350. The inner ramp 350 is configured to slide telescopically within the outer ramp 340 and allows the overall length of the ramp 300 to be adjusted. Fasteners 360, positioned symmetrically along the central axis of the ramp assembly 310, may be used to secure the inner ramp 350 in place relative to the outer ramp 340. These fasteners may prevent unwanted movement during use while evenly distributing the load across the structure.

At the upper end of the ramp assembly 310, a lip 370 is integrated to securely engage with elevated surfaces, for example couches or beds, preventing gaps or misalignment that could pose a safety risk. The lip 370 is configured to engage with the edge of an elevated surface, for example a couch or bed, to provide a flush and secure fit. In this regard, the lip 370 sits tightly against the elevated surface without gaps or misalignment, thereby eliminating any potential instability or unevenness. By creating a smooth and uninterrupted connection, the lip 370 allows pets to move from the ramp 300 onto the elevated surface safely and with ease

The telescopic column 320 acts as the support mechanism for the ramp assembly 310. It includes an outer column and an inner column, which are concentrically aligned to facilitate precise height adjustment. The round base 330 at the bottom of the telescopic column 320 provides a wide, stable foundation, for stabilizing the ramp and preventing tipping or slipping during use. The base 330 includes an anti-slip and anti-scratch surface to protect flooring and ensure the ramp remains stationary under varying load conditions.

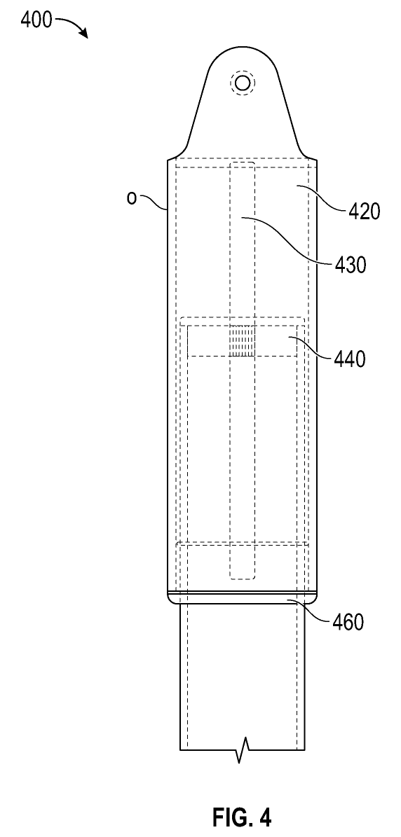

FIG. 4 illustrates a cross-sectional view of a telescopic column assembly 400 of a ramp, according to an embodiment. The telescopic column 400 includes an outer column 410 and an inner column 420, which are concentrically aligned to facilitate controlled linear movement of the inner column 420 within the outer column 410.

A threaded rod 430 is rigidly affixed to the interior of the outer column 410 and extends along its central longitudinal axis. The threaded rod 430 is configured to be the driver for height adjustment. A nut 440, securely fastened to the end cap of the inner column 420, is threaded to engage with the threaded rod 430. When the threaded rod 430 is rotated, the interaction between the threads of the rod 430 and the nut 440 translates rotational motion into linear motion, causing the inner column 420 to move vertically relative to the outer column 410. This mechanism allows for precise control of the inner column’s position and, consequently, the height of the ramp.

The assembly may include a glider 460, which is positioned between the outer column 410 and the inner column 420. The glider 460 is made of a low-friction material, for example nylon or polytetrafluoroethylene (PTFE), and is manufactured with precise tolerances to match the inner column’s diameter. The glider 460 reduces friction during operation and allows for smooth linear movement of the inner column 420 within the outer column 410. Additionally, the glider 460 acts as a protective barrier, preventing direct metal-to-metal contact between the columns. This may reduce wear on both the inner column 420 and outer column 410, thereby extending the operational lifespan of the telescopic column 400.

The described configuration provides controlled and precise height adjustability and also ensures that even under varying load conditions, the telescopic column 400 remains stable.

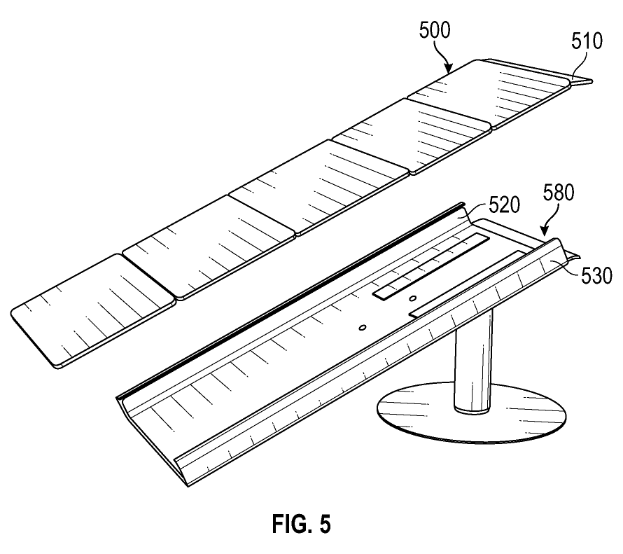

FIG. 5 illustrates a perspective view of a replaceable upholstery cover 500 of a ramp 580, according to an embodiment. In the embodiment shown, the upholstery cover 500 is attached to a ramp 580 using a hook and loop system 510, which allows the cover to be easily removed for cleaning or replacement. The hook and loop strips 510 are positioned along the edges of the inner ramp 520 and outer ramp 530 of the ramp 580 to prevent the cover 500 from shifting during use. This configuration also allows the upholstery cover 500 to adjust its length and conceal any excess material when the ramp 580 is extended or retracted.

In an embodiment, the hook and loop system 510 includes hook and loop strips adhered to the underside of the upholstery cover 500 and the corresponding surfaces of the inner ramp 520 and outer ramp 530 of the ramp 580. This attachment system helps cover 500 remain securely in place even under repeated use or heavy load conditions. The hook and loop mechanism allows for the upholstery cover 500 to be easily detached for cleaning, replaced, or swapped with a cover of a different color or material to suit user preferences. This embodiment allows pet owners to maintain hygiene and adapt the ramp 580 to their home décor with minimal effort.

In another embodiment, rope or elastic straps that loop around the edges of the inner ramp 520 and outer ramp 530 of the ramp 580 may be used. The elastic straps may be integrated into the upholstery cover 500 and may create a snug fit that holds the cover in place while allowing it to be stretched and removed as needed.

Another embodiment could include snap buttons, which are embedded into the edges of the ramp 580 and corresponding positions on the upholstery cover 500. The snap buttons may provide a rigid and reliable connection that can withstand repeated use. The snap-button system may allow the cover 500 to be replaced or cleaned while maintaining a tight and secure fit during operation.

Another embodiment may include magnetic strips integrated into the ramp’s surface and the underside of the upholstery cover 500. The magnetic force from the magnetic strips may fixedly attach the cover 500 to the ramp 580 while allowing it to be easily removed by peeling it away when replacement or cleaning is required.

Another embodiment may utilize zipper mechanisms along the sides of the inner ramp 520 and outer ramp 530 of the ramp 580. In this configuration, the upholstery cover 500 includes zippers integrated into its edges, which interlock with corresponding zippers on the ramp 580. This may prevent shifting or displacement, even under heavy loads. The zipper system allows for quick removal and replacement of the cover, which simplifies cleaning or swapping for alternative covers.

A feature illustrated in one of the figures may be the same as or similar to a feature illustrated in another of the figures. Similarly, a feature described in connection with one of the figures may be the same as or similar to a feature described in connection with another of the figures. Unless expressly described otherwise, the same or similar features may be noted by the same or similar reference characters. Additionally, the description of a particular figure may refer to a feature not shown in the particular figure. The feature may be illustrated in and/or further described in connection with another figure.

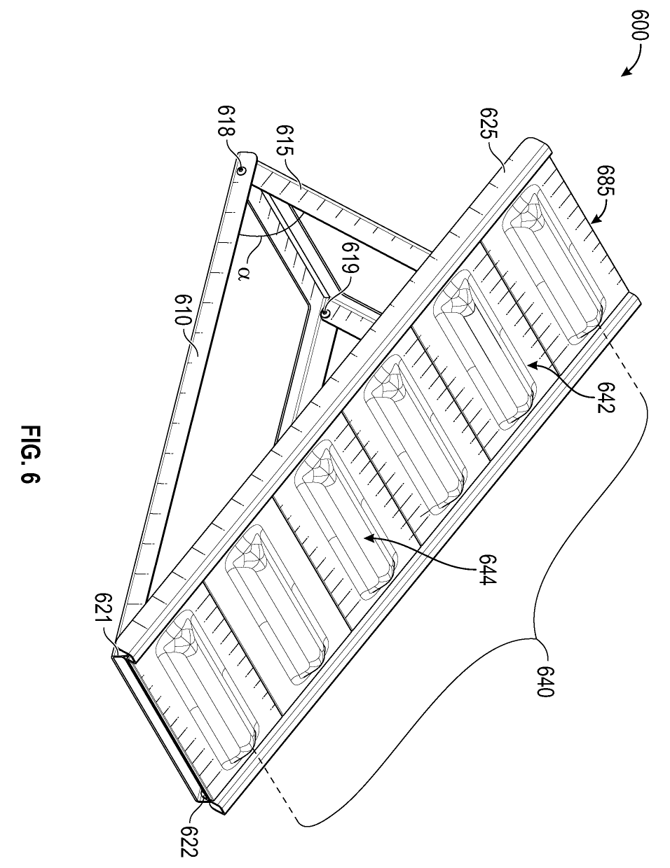

FIG. 6 illustrates a perspective view of a ramp 600 in a fully deployed state, according to an embodiment. The ramp includes several modular components designed for assembly and portability. Further, the ramp includes all elements working together to form a deployable, collapsible access ramp suitable for pets. Base 610 may be constructed of a single member or one or more members rigidly connected together. Base 610 is moveably connected to web riser 615 for holding up the ramp body 685 at hinges 618, 619. Hinges 621, 622 are located at the other end of the base 610 where it is moveable connected to ramp body 685.

Web riser 615 detachably connects to the underside of the ramp at ramp bottom 625. Web riser 615 can be attached to ramp bottom 625 at one or more angles α, which determines the grade of the incline for the ramp body 685. The smaller the angle α, the steeper the incline is for the ramp body 685. The ramp 600 may be constructed from 5032 H32 grade aluminum with thicknesses ranging from 1 mm to 3 mm for strength, durability, light weight, and a cost-effective solution.

Ramp cover 640 attaches to ramp body 685 on ramp 600. Ramp cover 640 may be one single piece or multiple pieces that assemble together into the ramp body 685. FIG. 5 shows ramp cover 640 comprising one or more tiles 642. The tiles may comprise an interlocking mechanism on each end of a tile so that it connects and locks with adjacent tiles for a stable ramp cover, providing less visible gaps in the structure when assembling or connecting the ramp cover together. In an embodiment of a ramp, where the ramp cover comprises one or more tiles for an interchangeable ramp cover design, allows for a variety of different ramp cover designs and structures to allow for different spacing and/or height of raised members, to adjust for the size of the pet and/or length of the pets leg, among other factors.

Ramp cover 640 may comprise one or more raised members 644 to provide better traction or grip for a pet to climb up the ramp. The ramp cover may be a rubber traction pad made of a rubber polymer with ridges. In another embodiment, the ramp cover may be made of a thermoplastic elastomer (TPE) or other plastic or polymer material, for a more cost effective approach. The raised members may be any number of shapes, for example, ridges, wedges, bumps, or similar like members that will provide better traction for the pet climbing the ramp. In an embodiment of the ramp cover, the ramp cover comprises a rubberized tread surface to aid in traction.

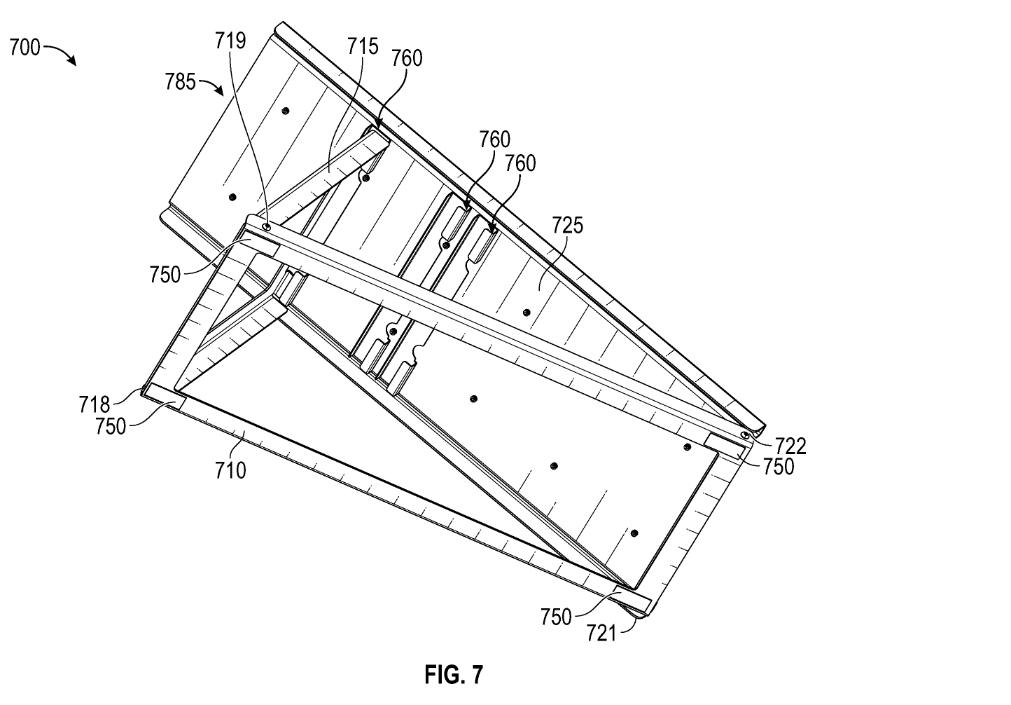

FIG. 7 illustrates a perspective underside view of a ramp 700 in a fully deployed state, according to an embodiment. The base 710 provides a stable foundation and may include feet 750 for grip to prevent the ramp from sliding during use by the pet. The feet may be made of a rubber, plastic, or a polymer material. The feet may comprise raised features for example nubs, bumps, or triangular points for grip. Further, the ramp includes all elements working together to form a foldable, collapsible access ramp suitable for pets and easy transportability. The feet are configured to stabilize the structure and may be interchangeable depending on floor surface. In an embodiment of the ramp, the feet comprise a rubberized tread surface to aid in traction.

Base 710 is moveably connected to web riser 715 for holding up the ramp body 785 at hinges 718, 719. Hinges 721, 722 are located at the other end of the base 710 where it is moveable connected to ramp body 785. The hinge connections provide the user the ability to easily fold or collapse the ramp for storage and transport. The hinge connection may any type of moveable or rotatable connection that allows for adjacent parts to move and fold or collapse the ramp.

One or more brackets 760 are rigidly connected to the underside of the ramp body 785 on ramp bottom 725. The brackets 760 are located at various positions on the ramp bottom 725 to raise or lower the ramp incline to a desired position. The Web riser 715 detachably connects to a bracket 760 to hold the ramp in a desired position. The bracket supports an intermediate platform in various positions.

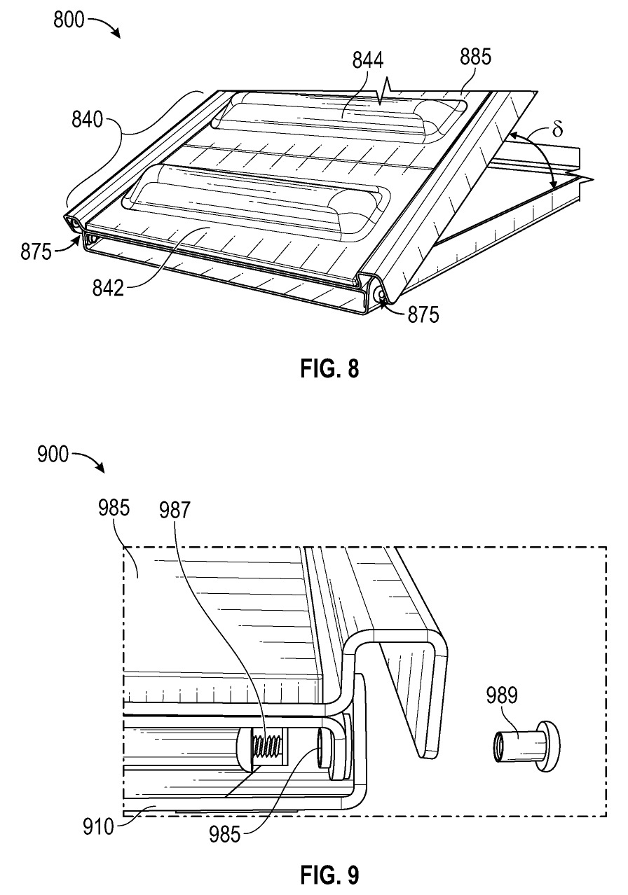

FIG. 8 illustrates a perspective view of a folding mechanism 800, according to an embodiment. The folding mechanism allows the user to fold and adjust the ramp to one or more height levels and incline angles δ. Ramp cover 840 may be one single piece or multiple pieces that assemble together into the ramp body 885. FIG. 8 shows a portion of ramp cover 640 with multiple tiles 842. In an embodiment of the ramp cover 640, the ramp cover may comprise one or more ridges 844 to provide better traction or grip for a pet to climb up the ramp.

FIG. 9 illustrates a cross-sectional view of a folding mechanism 900, according to an embodiment. In an embodiment of the folding mechanism, the folding mechanism 900 is makes the ramp 900 foldable and attaches to the base 910 via a hinge mechanism 985, allowing for angled deployment or collapsing the ramp for storage and transport. The hinge mechanism 985, comprises a pivot screw 987 to provide a fixed axis of rotation for the hinge while maintain controlled clearance. Further, the hinge mechanism comprises a pivot pin 989 which acts as the rotating element or bushing surface that the hinged part rotates around. The pivot pin 989 fits over or around the pivot screw and rotates freely. Load is carried by the shoulder-to-pin interface, not by threads. This prevents wear, binding, and loosening over repeated cycles.

In another embodiment, the folding mechanism may comprise a hollow rectangular housing integrated into a panel or frame. Inside a cavity may be a compression spring pushing against a sliding cylindrical plunger. A plunger may be aligned horizontally and constrained so it can move in and out but not rotate. A hook-shaped cam feature (part of the moving lid or hinge arm) may curve downward toward the plunger. A separate cylindrical cap may be used to retain the spring and plunger during assembly (press-fit or snap-in).

A spring-loaded plunger engages with a hooked cam surface may create a snap-in, self-retaining hinge or latch mechanism that locks when closed and releases when rotated open.

In alternative embodiments, other folding mechanisms may be used, for example, (a) shoulder bolt and hinge pin, (b) pivot screw and dowel pin, (c) shoulder fastener and barrel pin, or (d) clevis pin (if retained with clips instead of threads).

The components of the embodiments of adjustable ramps may be constructed from plastic, metal, or composite materials, depending on strength and manufacturing constraints.

The assembly of the embodiments of adjustable ramps may use fasteners or snap-fit connections, and some elements may be replaceable or adjustable to suit different height applications.

Elements of processes (i.e., methods) described herein may be executed in one or more ways, such as by a human, a processing device, mechanisms operating automatically or under human control, and so forth. Additionally, although various elements of a process may be depicted in the figures in a particular order, the elements of the process may be performed in one or more different orders without departing from the substance and spirit of the disclosure herein.

The preceding description sets forth numerous details such as examples of specific systems, components, methods, and so forth, to provide a good understanding of several implementations. However, it will be apparent to one skilled in the art that at least some implementations may be practiced without these specific details. In other instances, well-known components or methods are not described in detail or are presented in simple block diagram format to avoid unnecessarily obscuring the present implementations. Thus, the specific details set forth above are merely exemplary. Particular implementations may vary from these exemplary details and still be within the scope of the present implementations.

Related elements in the examples and/or embodiments described herein may be identical, similar, or dissimilar in different examples. For brevity and clarity, related elements may not be redundantly explained. Instead, the use of same, similar, and/or related element names and/or reference characters may cue the reader that an element with a given name and/or associated reference character may be similar to another related element with the same, similar, and/or related element name and/or reference character in an example explained elsewhere herein. Elements specific to a given example may be described regarding that particular example. A person having ordinary skill in the art will understand that a given element need not be the same and/or similar to the specific portrayal of a related element in any given figure or example to share features of the related element.

It is to be understood that the foregoing description is intended to be illustrative and not restrictive. Many other implementations will be apparent to those of skill in the art upon reading and understanding the above description. The scope of the present implementations should, therefore, be determined with reference to the appended claims, along with the full scope of equivalents to which such claims are entitled.

The foregoing disclosure encompasses multiple distinct examples with independent utility. While these examples have been disclosed in a particular form, the specific examples disclosed and illustrated above are not to be considered in a limiting sense as numerous variations are possible. The subject matter disclosed herein includes novel and non-obvious combinations and sub-combinations of the various elements, features, functions, and/or properties disclosed above both explicitly and inherently. Where the disclosure or subsequently filed claims recite “a” element, “a first” element, or any such equivalent term, the disclosure or claims are to be understood to incorporate one or more such elements, neither requiring nor excluding two or more such elements.

As used herein “same” means sharing all features and “similar” means sharing a substantial number of features or sharing materially important features even if a substantial number of features are not shared. As used herein “may” should be interpreted in a permissive sense and should not be interpreted in an indefinite sense. Additionally, use of “is” regarding examples, elements, and/or features should be interpreted to be definite only regarding a specific example and should not be interpreted as definite regarding every example. Furthermore, references to “the disclosure” and/or “this disclosure” refer to the entirety of the writings of this document and the entirety of the accompanying illustrations, which extends to all the writings of each subsection of this document, including the Title, Background, Brief Description of the Drawings, Detailed Description, Claims, Abstract, and any other document and/or resource incorporated herein by reference.

As used herein regarding a list, “and” forms a group inclusive of all the listed elements. For example, an example described as including A, B, C, and D is an example that includes A, includes B, includes C, and also includes D. As used herein regarding a list, “or” forms a list of elements, any of which may be included. For example, an example described as including A, B, C, or D is an example that includes any of the elements A, B, C, and D. Unless otherwise stated, an example including a list of alternatively-inclusive elements does not preclude other examples that include various combinations of some or all of the alternatively-inclusive elements. An example described using a list of alternatively-inclusive elements includes at least one element of the listed elements. However, an example described using a list of alternatively-inclusive elements does not preclude another example that includes all of the listed elements. And, an example described using a list of alternatively-inclusive elements does not preclude another example that includes a combination of some of the listed elements. As used herein regarding a list, “and/or” forms a list of elements inclusive alone or in any combination. For example, an example described as including A, B, C, and/or D is an example that may include: A alone; A and B; A, B, and C; A, B, C, and D; and so forth. The bounds of an “and/or” list are defined by the complete set of combinations and permutations for the list.

Where multiples of a particular element are shown in a FIG. or figure, and where it is clear that the element is duplicated throughout the FIG., only one label may be provided for the element, despite multiple instances of the element being present in the FIG. Accordingly, other instances in the FIG. of the element having identical or similar structure and/or function may not have been redundantly labeled. A person having ordinary skill in the art will recognize based on the disclosure herein redundant and/or duplicated elements of the same FIG. Despite this, redundant labeling may be included where helpful in clarifying the structure of the depicted examples.

The Applicant(s) reserves the right to submit claims directed to combinations and sub-combinations of the disclosed examples that are believed to be novel and non-obvious. Examples embodied in other combinations and sub-combinations of features, functions, elements, and/or properties may be claimed through amendment of those claims or presentation of new claims in the present application or in a related application. Such amended or new claims, whether they are directed to the same example or a different example and whether they are different, broader, narrower, or equal in scope to the original claims, are to be considered within the subject matter of the examples described herein.

1. An apparatus, comprising:
a telescopic support column having an outer column and an inner column, the inner column configured to slide vertically within the outer column and further comprising a threaded rod disposed within the outer column, the threaded rod engaging a nut coupled to the inner column to enable precise height adjustment;
a base coupled to the telescopic support column, the base being round, anti-slip, and anti-scratch to provide stability on floor surfaces;
an extendable ramp comprising an outer ramp and an inner ramp, the inner ramp configured to slide longitudinally relative to the outer ramp, and further secured in position via a one or more fasteners disposed along a central axis of the ramps to lock the inner ramp at a desired length;
a hinge assembly pivotally connecting the extendable ramp to the telescopic support column, the hinge comprising a pin extending through aligned apertures of a bracket fixed to the outer ramp and a connection mechanism affixed to the telescopic support column;
a lip disposed at an end of the ramp opposite the hinge, the lip configured to engage with an elevated surface to provide a secure, gap-free connection; and
a replaceable upholstery cover extending along a top surface of the ramp, the cover comprising non-slip material and being adjustable in length to conform to the ramp’s extension, the cover attachable via hook-and-loop fasteners, snap buttons, or magnetic elements.

2. The device of claim 1, wherein the base includes a textured elastomeric surface layer bonded to the underside of the base, the layer comprising a pattern of raised nubs or ridges configured to prevent lateral sliding and protect underlying floor surfaces.

3. The device of claim 1, wherein the upholstery cover comprises a thermoplastic elastomer (TPE) outer layer bonded to a flexible backing material, the outer layer including molded tread patterns such as ridges, grooves, or waveforms to increase paw traction during use.

4. The device of claim 1, herein the hinge assembly includes a ball-and-socket joint coupled to the pin, allowing multi-axis pivoting of the ramp relative to the telescopic support column to accommodate uneven or angled surfaces.

5. The device of claim 1, wherein the glide assembly comprises a cylindrical sleeve composed of a low-friction polymer positioned concentrically between the inner and outer columns to reduce wear and facilitate smooth vertical motion during height adjustment.

6. The device of claim 1, wherein the fasteners securing the inner ramp to the outer ramp include hand-operable wing nuts mounted to threaded studs extending through aligned apertures in the ramp members, allowing tool-free locking of the ramp length.

7. A system, comprising:
a foldable base having a first end pivotally connected to a ramp body and a second end connected to a web riser, the base and web riser supporting the ramp body at an adjustable incline;
the ramp body comprising:
a ramp cover removably attached to an upper surface of the ramp body, the ramp cover including one or more tiles having raised traction members;
a set of hinges positioned between the base and the ramp body, and between the base and the web riser, configured to enable folding of the ramp system for storage; and
one or more brackets disposed on an underside of the ramp body and configured to engage with the web riser to set a selectable incline angle.

8. The system of claim 7, wherein the web riser is configured to telescopically extend and includes notched engagement slots along its length that interact with locking tabs on the bracket to provide multiple fixed incline angles.

9. The system of claim 7, wherein the ramp cover tiles are fabricated from vulcanized rubber or molded elastomer and include integrated raised members in the form of repeating ridge patterns oriented perpendicularly to the ramp incline to enhance grip for ascending pets.

10. The system of claim 7, wherein the snap-fit mechanisms include resilient clips integrated into the ramp tiles, each configured to engage corresponding receptacles on the ramp body to facilitate rapid attachment and detachment without tools.

11. The system of claim 7, wherein the base includes four independent feet composed of thermoplastic rubber, each foot having a triangular tread pattern on the bottom surface to provide multidirectional traction on hardwood, tile, or carpet surfaces.

12. The system of claim 7, wherein the web riser comprises a telescoping riser assembly having at least two nested riser segments that are extendable relative to one another, and further includes an integrated locking mechanism configured to secure the riser at discrete height settings for adjusting the ramp incline.

13. A device, comprising:
a length-adjustable ramp structure; a support mechanism configured to:
elevate the ramp at a plurality of incline angles; and
stabilize the ramp at the plurality of incline angles; and a non-slip surface disposed on the ramp structure.

14. The device of claim 13, wherein the support mechanism comprises a telescopic column with nested segments and an internal mechanical drive system including a threaded rod and nut for adjusting vertical height by rotational actuation.

15. The device of claim 13, wherein the ramp structure includes a telescoping assembly with an inner ramp slidable within an outer ramp track, the assembly further comprising mechanical detents or fasteners to maintain fixed length during operation.

16. The device of claim 13, wherein the non-slip surface comprises a removable upholstery cover having a grip-enhancing tread formed of flexible thermoplastic with raised surface textures and securement points positioned along opposing ramp edges.

17. The device of claim 13, wherein the ramp structure includes folding joints with integrated locking hinges positioned at midpoints along the ramp length, enabling the ramp to collapse into a compact configuration for storage.

18. The device of claim 13, further comprising a hinge coupled between the support mechanism and the ramp structure, the hinge configured with a rotational stop limiting pivoting to a defined angular range to maintain ramp safety during use.

19. The device of claim 13, wherein the ramp includes an upper lip portion formed from molded plastic or aluminum and comprising a contoured bottom surface and raised rear flange for engaging an edge of an elevated surface without slipping.

20. The device of claim 13, wherein the ramp structure comprises a multi-layer laminate including a structural core layer formed of aluminum, an intermediate elastomeric impact-dampening layer, and a wear-resistant outer surface textured for traction and durability.
